(19) United States
(12) Patent Application Publication
(10) Pub. No.: US 2015/0131698 A1
(43) Pub. Date: May 14, 2015

(54) LOW TEMPERATURE RTP CONTROL USING IR CAMERA

(71) Applicant: Applied Materials, Inc., Santa Clara, CA (US)

(72) Inventors: Kim VELLORE, San Jose, CA (US); Dinesh KANAWADE, Sunnyvale, CA (US); Leonid M. TERTITSKI, Los Gatos, CA (US); Norman L. TAM, Cupertino, CA (US); Aaron Muir HUNTER, Santa Cruz, CA (US)

(21) Appl. No.: 14/517,060

(22) Filed: Oct. 17, 2014

Related U.S. Application Data
(60) Provisional application No. 61/902,564, filed on Nov. 11, 2013.

(51) Int. Cl. G01J 5/50; H05B 3/00

(52) U.S. Cl. CPC G01J 5/505; H05B 3/0047; G01J 2005/0077
USPC 374/130; 392/411

(57) ABSTRACT

Embodiments of the present invention generally relate to methods and apparatus for monitoring substrate temperature uniformity in a processing chamber, such as an RTP chamber. Substrate temperature is monitored using an infrared camera coupled to a probe having a wide-angle lens. The wide-angle lens is positioned within the probe and secured using a spring, and is capable of withstanding high temperature processing. The wide angle lens facilities viewing of substantially the entire surface of the substrate in a single image. The image of the substrate can be compared to a reference image to facilitate lamp adjustments, if necessary, to effect uniform heating of the substrate.

### CROSS-REFERENCE TO RELATED APPLICATIONS

This application claims benefit of U.S. Provisional Patent Application Ser. No. 61/902,564, filed Nov. 11, 2013, which is herein incorporated by reference.

### BACKGROUND OF THE INVENTION

1. Field of the Invention

Embodiments of the present invention generally relate to visual feedback in rapid thermal processing chambers used for processing substrates, such as semiconductor substrates.

2. Description of the Related Art

Rapid thermal processing chambers include a plurality of lamps therein which are used for rapidly heating a substrate to a desired temperature before allowing the substrate to cool. Uniform heating across the substrate is desirable to ensure substrate-to-substrate uniformity, and well as uniform processing across individual substrates. Typically, substrate heating uniformity is measured using a plurality of pyrometers directed to measure the substrate temperature at multiple points across the substrate surface. However, the pyrometers only provide point measurements of substrate temperature, and heating uniformity must be inferred from this limited number of pyrometer measurements. Additionally, it is space-prohibitive and cost-prohibitive to increase the number of pyrometers to an amount sufficient to provide an accurate, overall indication of substrate temperature uniformity.

Therefore, there is a need for an improved method and apparatus for monitoring substrate temperature uniformity.

### SUMMARY OF THE INVENTION

Embodiments of the present invention generally relate to methods and apparatus for monitoring substrate temperature uniformity in a processing chamber, such as an RTP chamber. Substrate temperature is monitored using an infrared camera coupled to a probe having a wide-angle lens. The wide-angle lens is positioned within the probe and secured using a spring, and is capable of withstanding high temperature processing. The wide angle lens facilities viewing of substantially the entire surface of the substrate in a single image. The image of the substrate can be compared to a reference image to facilitate lamp adjustments, if necessary, to effect uniform heating of the substrate.

In one embodiment, a process chamber comprises a chamber body, a lamp array disposed in the chamber body, a lid disposed over the chamber body, a probe disposed through an opening in the chamber lid, the probe having a wide-angle lens array at a first end of the probe, and an infrared camera coupled to a second end of the probe.

In another embodiment, a method of monitoring lamp performance in a process chamber comprises capturing an image of a substrate within the process chamber using an infrared camera and a wide-angle lens array, transferring the captured image to a control unit, and comparing the captured image to a reference image to determine if the substrate has a desired temperature uniformity.

In another embodiment, a process chamber comprises a chamber body; a lamp array disposed in the chamber body; a lid disposed over the chamber body; a probe disposed through an opening in the chamber lid, the probe having a wide-angle array at a first end of the probe, wherein the probe comprises a housing and a spring positioned therein, and wherein the wide-angle lens array comprises a plurality of lenses; and a camera coupled to a second end of the probe.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A and 1B are schematic views of a process chamber, according to one embodiment of the invention.

FIG. 2 is a schematic sectional view of a probe, according to one embodiment of the invention.

FIGS. 3A illustrates a probe coupled to optics of a camera.

FIG. 3B illustrates a wide angle lens assembly, according to another embodiment of the invention.

FIG. 4 illustrates a flow diagram of a method of monitoring lamp performance, according to one embodiment of the invention.

FIG. 5 illustrates an image of a substrate captured by an infrared camera of the present invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention generally relate to methods and apparatus for monitoring substrate temperature uniformity in a processing chamber, such as an RTP chamber. Substrate temperature is monitored using an infrared camera coupled to a probe having a wide-angle lens. The wide-angle lens is positioned within the probe and secured using a spring, and is capable of withstanding high temperature processing. The wide angle lens facilities viewing of substantially the entire surface of the substrate in a single image. The image of the substrate can be compared to a reference image to facilitate lamp adjustments, if necessary, to effect uniform heating of the substrate.

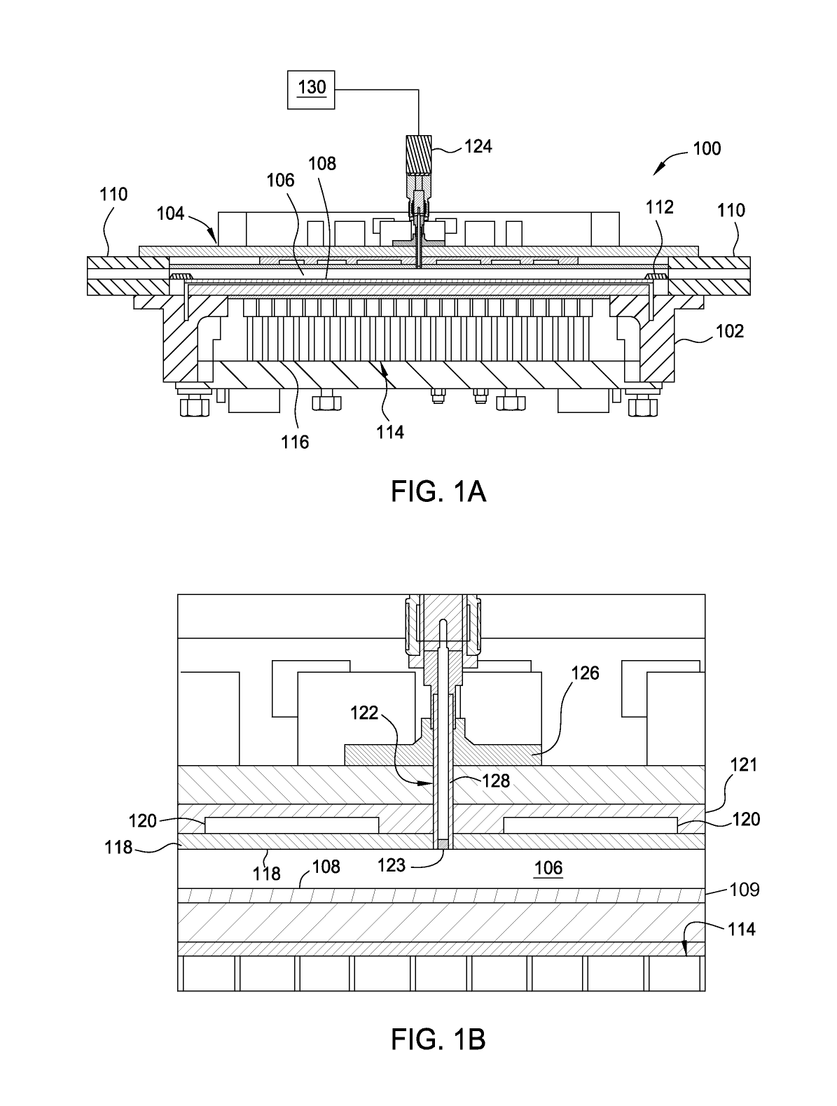

FIGS. 1A and 1B are schematic views of a process chamber, according to one embodiment of the invention. The process chamber 100 may be a rapid thermal processing (RTP) chamber available from Applied Materials, Inc., of Santa Clara, Calif. The process chamber 100 includes a body 102 formed from, for example, stainless steel or aluminum, and adapted to support a chamber lid 104 thereon. A process region 106 is defined between the chamber body 102 and the chamber lid 104. A substrate support 109 is positioned at the lower portion of the process region 106 within the chamber body 102. The substrate support 109 is adapted to support a substrate, such as a semiconductor substrate, thereon during processing within the process chamber 100. The substrate support 109 may be formed from an optically transparent material, such as quartz, to facilitate the heating of the substrate 108 using optical radiation.

Plenums 110 are coupled to the chamber body 102 and are adapted to provide and remove one or more process gases to/from the process region 106 during processing. In one example, a first plenum 110 may be adapted to provide a process gas to the process region 106, while a second plenum 110 may be adapted to remove reactant by-products and unreacted process gas from the process region 106. Process gas entering the process chamber 100 through a plenum 110 is directed over a pre-heat ring 112 prior to entering the process region 106. The pre-heat ring 112 may be formed from silicon carbide or graphite and facilitates heating of the process gas while providing edge protection to the substrate 108. The pre-heat ring 112 includes a circular opening disposed centrally therethrough. The opening has a diameter less than the substrate 108, such as about 1 millimeter less to about 10 millimeters less, in order to cover the edge of the substrate 108 during processing. Thus, the pre-heat ring 112 may also function as a clamp ring. The pre-heat ring 112 is actuatable between a process position (as shown in FIG. 1A) and a raised position above the process position which facilitates removal of the substrate 108 from the process chamber 100.

The process chamber 100 also includes a lamp array 114 disposed in a lower portion of a chamber body 102. The lamp array 114 includes a plurality of lamps 116, such as incandescent lamps, arranged in a close-packed hexagonal array. The lamp array 114 may be subdivided into zones of lamps 116 that may be controlled individually. The lamp array 114 is adapted to direct optical radiation towards the substrate 108 to rapidly elevate the temperature of the substrate 108 to a desired processing temperature. For example, the substrate 108 may be heated from about 20 degrees Celsius to about 800 degrees Celsius or about 1200 degrees Celsius to perform an anneal process on the substrate 108. In another example, the substrate 108 may be heated to a temperature less than about 400 degrees Celsius or less than about 300 degrees Celsius.

The lid 104 includes a reflector plate 118 disposed on a lower surface thereof adjacent to the process region 106. The reflector plate 118 is adapted to reflect optical radiation back to the upper surface of substrate 108 to provide more efficient heating of the substrate 108 and facilitate temperature control of the lid 104. To further facilitate temperature control of the lid 104, the lid 104 includes cooling passages 120 formed in a cooling body 121 to allow a cooling fluid to flow therethrough to remove heat from the lid 104 via a heat exchanger (not shown).

The lid 104 includes an opening therethrough to accommodate a probe 122. The opening to accommodate the probe 122 may be centrally disposed relative to the substrate 108 and lamp array 114, or may be offset from the centers thereof. The probe 122 includes optical elements therein to facilitate transferring of an image of the internal chamber volume, for example, an image of the upper surface of a substrate 108, to a camera 124, such as an infrared (IR) camera. A wide-angle lens 123 (e.g., a “fish eye” lens) is disposed at the lower end of the probe 122. The wide angle lens 123 may have a viewing angle of about 160 degrees to about 170 degrees, such as about 163 degrees to facilitate viewing of substantially all the entire upper surface of the substrate 108, or at least portions of the substrate 108 not covered by a preheat or clamp ring. The probe may be formed, for example, from aluminum or an alloy thereof.

The probe 122 is disposed through the reflector plate 118 and the cooling body 121 and facilitates image capturing by the camera 124. The probe 122 is secured in place via a bracket 126 coupled to an upper surface of the lid 104. A seal 128 is disposed around the probe 122 between the probe 122 and the bracket 126 to mitigate the escape of process gases from the processing region 106. The probe may have a length of about 2 inches to about 1 foot, for example, about 5 inches to about 7 inches, to distance the camera 124 from the process region 106, thereby subjecting the camera 124 to less heat, thus reducing the likelihood of heat-related damage to the camera 124.

The camera 124 is adapted to capture an image of the substrate 108 and transfer the image to a control unit 130. The control unit 130 may be, for example, a computer, and include one or more processors or memories to facilitate the computing of data. In one example, the control unit 130 is adapted to receive data, such as an image, form the camera 124 and compare the image to a second image (e.g. a reference image) stored in a memory of the computer. Based on the comparison results, the control unit 130 may cause a change in process conditions via closed-loop control. For example, the control unit 130 may increase the power applied to one or more lamps, thus increasing lamp intensity and localized heating.

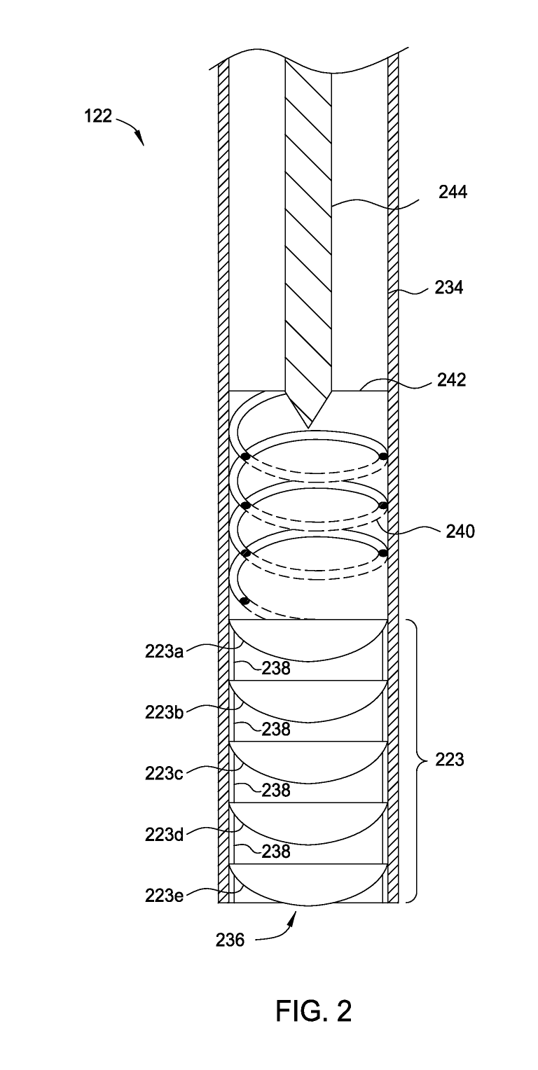

FIG. 2 is a schematic sectional view of a probe 122, according to one embodiment of the invention. The probe 122 includes a housing 234, such as a stainless steel tube. A wide-angle lens array 223 is disposed in a lower portion of the housing adjacent to an aperture 236. The aperture 236 may have a relatively small diameter, such as about 3 millimeters to about 7 millimeters, to limit the amount of optical radiation that enters the probe 122, thereby reducing undesired heating of the probe 122. The wide-angle lens array 223 includes five lenses 223a-223e positioned vertically above one another. The lenses 223a-223e may be formed from glass or quartz and are separated by spacers 238 disposed along the inner surface of the housing 234. The utilization of a wide angle lens array 223 facilitates a wider viewing angle than a single lens having the combined thickness and the same curvature. It is to be understood that the inclusion of five lenses is only an example, and more or less than 5 lenses may be utilized in the probe 122.

Each lens 223a-223e is secured in place using a spring 240 that coils around the inner surface of the housing 234. Portions of the spring 240 which would otherwise not be visible in the sectional view are shown in phantom to facilitate explanation. The spring 240 abuts a spring support 242 disposed within the housing 234, and exerts pressure against the uppermost lens 223a. The force is then transferred through the spacers 238 and remaining lenses 223b-223e to secure the lenses 223a-223e against the bottom portion of the housing 234. In this manner, the use of glues or other bonding compounds, which can degrade in the high temperature atmosphere of the processing region 106, can be avoided. In one embodiment, the lenses 223a-223e have the same curvature on a surface thereof. However, it is contemplated that the curvature of the lenses 223a-223e may be different in order to effect the desired field of view from the wide-angle lens array 223.

A gradient index (GRIN) rod lens 244 is disposed through an opening centrally formed in the spring support 242. The GRIN rod lens 244 achieves focus via a continuous change of the refractive index within the lens material. The GRIN rod lens 244 may be coupled to an optics assembly, for example, a lens of the camera (shown in FIG. 1A) to facilitate focusing of the image for capture by the camera 124. In one embodiment, a top surface of the GRIN rod lens 244 may be sealed with an epoxy to provide a vacuum-tight seal within the probe 122.

Prior art attempts to capture images of lamp arrays with cameras were unsuccessful because the prior optic assemblies were unable to withstand the high temperatures generated by the lamp arrays in the proximity of the process region. The utilization of the probe 122 facilitates use adjacent a high temperature environment due to the ability of the probe 122 to withstand high temperatures and large temperature fluctuations, thereby allowing along the use of a camera without harming the camera 124 or probe 122 due to excessive heat. During processing, the probe 122 may reach temperatures of about 800 degrees Celsius or less, such as about 400 degrees Celsius or less. However, as illustrated in FIG. 1A, the probe 122 passes through the cooling body 121, which assists in temperature management of the probe 122 by removing heat therefrom.

FIG. 2 illustrates one embodiment of a probe 122; however, additional embodiments are also contemplated. In another embodiment, it is contemplated that the wide-angle lens array 223 may contain more or less lenses than five lenses 223a-223e, as is necessary to obtain the desired viewing angle.

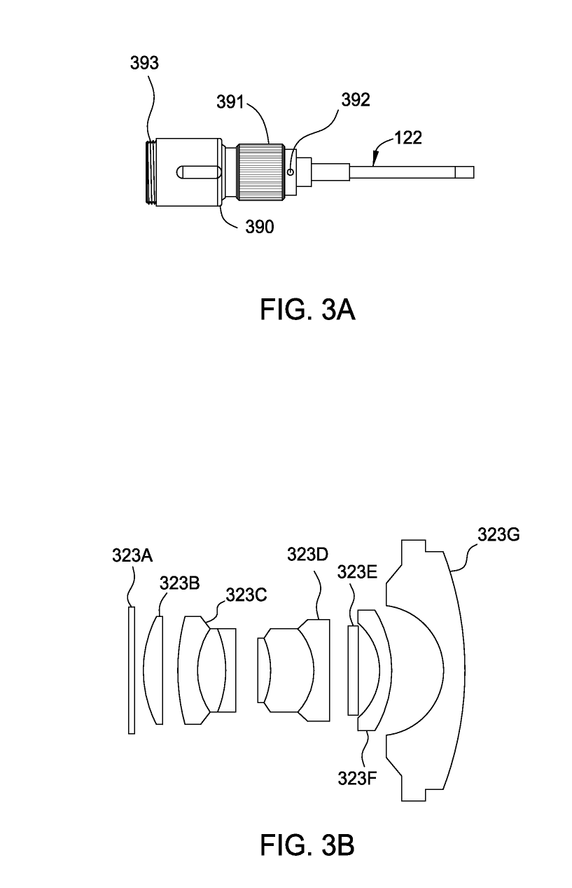

FIGS. 3A illustrates a probe 122 coupled to optics 390 of a camera 124 (shown in FIG. 1A). The probe 122 may be coupled to a focusing section 391 of the optics 390, and secured via a set screw 392. The optics 390 may be secured to the camera 124 via threads 393. The focusing section 391 may provide a depth of focus at the substrate plane to increase the accuracy of substrate temperature determination by ignoring or not collecting undesired IR radiation or reflection, for example, from chamber components adjacent the substrate.

FIG. 3B illustrates a wide angle lens assembly 323, according to another embodiment of the invention. The wide angle lens assembly includes six lenses 323A-323G to facilitate a desired viewing angle within a process chamber. The wide angle lens assembly may be disposed within a probe 122. As illustrated by FIG. 3B, the lenses 323A-323G may have different shapes and curvatures, as desired, in order to effect the desired viewing angle. Additionally, the lenses 323A-323G may be in contact with one another, or may include spacers therebetween. In another embodiment, it is contemplated that lenses 323e and 323f may be combined into a single lens.

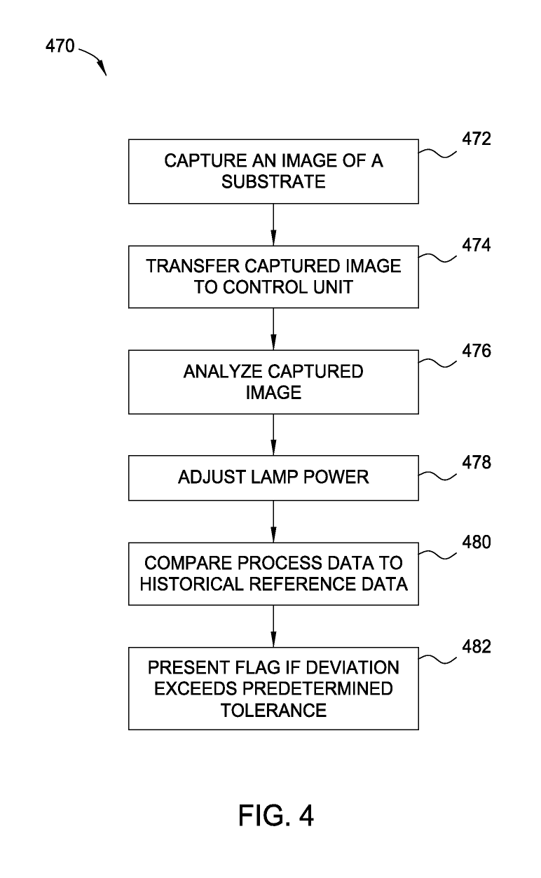

FIG. 4 illustrates a flow diagram 470 of a method of monitoring substrate temperature uniformity, according to one embodiment of the invention. Flow diagram 470 begins at operation 472. In operation 472, an image of a substrate within a process chamber is captured, real-time, using a wide-angle lens, such as the wide-angle lens 123 within the probe 122 (shown in FIG. 1B), and an infrared camera. The captured image is then transferred to a control unit, such as control unit 130 shown in FIG. 1A, in operation 474. The control unit facilitates determination of substrate temperature uniformity, for example, by comparison of the captured image to a reference image stored on the control unit in operation 476, or by using a software algorithm to analyze the captured image.

In operation 478, the output of the lamps is adjusted to facilitate temperature uniformity across the substrate. For example, selective lamp zones may be subjected to increased power supply to facilitate increased local heating of the substrate in areas adjacent the selective lamp zones. Thus, control of lamp zones (or individual lamps) based on heat radiated from a substrate as measured by an IR camera is possible. In operation 480, the processing data of the wafer is compared to historical reference data. For example, the amount of power provided to each lamp zone for processing the present substrate is compared to historical data. In operation 482, a flag is presented to an operator if a processing condition of the present substrate deviated from the historical data by greater than a predetermined tolerance. Thus, an operator is informed that the process chamber may require maintenance. Additionally, comparison of historical profiles facilitates consistent substrate-to-substrate processing. In another embodiment, it is contemplated that the wafer may be rotated during operations 472-482.

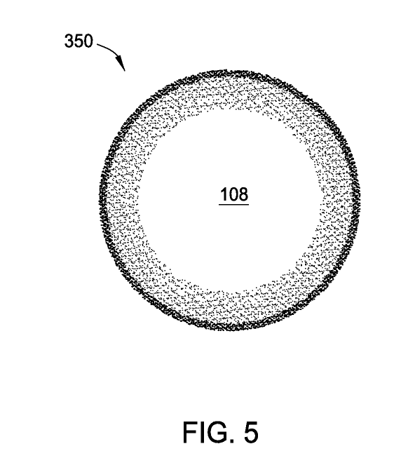

FIG. 5 illustrates a captured image 350 of the substrate 108 as viewed through a wide-angle lens, such as the wide-angle lenses 223a-223e illustrated in FIG. 2. The wide-angle lenses allows for viewing of substantially all of the substrate 108 even though the substrate 108 is positioned relatively close to the wide-angle lenses. For example, the distance between the lamps 116 and the wide-angle lens may be less than about 5 inches or less than about 3 inches. The utilization of the wide-angle lens array 223 allows the chamber volume to be kept relatively small. The grayscale variations across the captured image 350 indicate temperature variations. Background imaging, such as chamber surroundings, are not shown for purposes of clarity.

In one example, the control unit may include an algorithm to convert the captured wide-angle image shown in FIG. 5 into a more conventional, planar image. It is contemplated that converting the image from a wide-angle format may expedite the process of comparing the image to the baseline image.

Benefits of the invention include optical identification of substrate temperature uniformity. The utilization of an infrared camera and a wide angle lens allow for determining the temperature of the entire surface of the substrate, rather than just discrete points as previously done using pyrometers. The utilization of the wide angles lens and the infrared camera is facilitate by use of a probe adapted to withstand elevated processing temperatures utilized in thermal processing chambers. Additionally, the benefits include control of lamp zones based on heat radiated from a substrate as measured by an IR camera.

While the foregoing is directed to embodiments of the present invention, other and further embodiments of the invention may be devised without departing from the basic scope thereof, and the scope thereof is determined by the claims that follow.

What is claimed is:

1. A process chamber, comprising:
a chamber body;
a lamp array disposed in the chamber body;
a lid disposed over the chamber body;
a probe disposed through an opening in the chamber lid, the probe having a wide-angle lens array at a first end of the probe; and
an infrared camera coupled to a second end of the probe.

2. The process chamber of claim 1, wherein the wide-angle lens array comprises a plurality of lenses separated by spacers.

3. The process chamber of claim 1, wherein the probe comprises a housing and a spring positioned therein.

4. The process chamber of claim 1, wherein the lid includes cooling channels therein.

5. The process chamber of claim 1, wherein the wide-angle lens array has a viewing angle of about 160 degrees to about 170 degrees.

6. The process chamber of claim 1, wherein the lid includes cooling channels therein, the cooling channels in thermal communication with the probe.

7. A method of monitoring lamp performance in a process chamber, comprising:
capturing an image of a substrate within the process chamber using an infrared camera and a wide-angle lens array;
transferring the captured image to a control unit; and
determining uniformity from the captured image.

8. The method of claim 7, further comprising adjusting the power provided to one or more lamps in the lamp array after comparing the captured image to a reference image.

9. The method of claim 7, further comprising elevating a pre-heat ring within the process chamber prior to the capturing an image.

10. The method of claim 7, wherein a transparent substrate is located within the process chamber while capturing the image.

11. The method of claim 7, wherein determining uniformity from the captured image comprises comparing the captured image to a reference image.

12. A process chamber, comprising:
a chamber body;
a lamp array disposed in the chamber body;
a lid disposed over the chamber body;
a probe disposed through an opening in the chamber lid, the probe having a wide-angle lens array at a first end of the probe, wherein the probe comprises a housing and a spring positioned therein, and wherein the wide-angle lens array comprises a plurality of lenses; and
a camera coupled to a second end of the probe.

13. The process chamber of claim 12, wherein the housing of the probe comprises stainless steel.

14. The process chamber of claim 13, wherein the wide-angle lens array has a viewing angle of about 160 degrees to about 170 degrees.

15. The process chamber of claim 14, wherein the lid includes cooling channels therein, the cooling channels in thermal communication with the probe.

16. The process chamber of claim 15, wherein the camera is an infrared camera.

17. The process chamber of claim 12, wherein the lid includes a reflector plate coupled thereto, and wherein the probe is disposed through the reflector plate.

18. The process chamber of claim 17, wherein the housing of the probe comprises stainless steel.

19. The process chamber of claim 18, wherein the housing includes an aperture having a diameter of about 3 millimeters to about 7 millimeters.

20. The process chamber of claim 12, wherein the lid includes cooling channels therein, the cooling channels in thermal communication with the probe.
